(19) United States
(12) Patent Application Publication
(10) Pub. No.: US 2026/0258953 A1
(43) Pub. Date: Sep. 3, 2026

(54) GAS STOVE AND METHOD FOR MOUNTING SAME

(71) Applicant: JUNSKY APPLIANCES LIMITED, Zhongshan (CN)

(72) Inventors: Huiqiang Zhu, Zhongshan (CN); Haiyang Yan, Zhongshan (CN); Rongzhang Liang, Zhongshan (CN); Zixuan Lu, Zhongshan (CN); Zhigang Jiang, Zhongshan (CN)

(21) Appl. No.: 19/227,306

(22) Filed: Jun. 3, 2025

(30) Foreign Application Priority Data
Mar. 3, 2025 (CN) 202510242584.1

(51) Int. Cl. F24C 3/12; F24C 15/08

(52) U.S. Cl. CPC F24C 3/124; F24C 15/08

(57) ABSTRACT

The present invention relates to the field of kitchen gas stoves and methods for mounting same, in particular to a gas stove and a method for mounting same. The gas stove comprises a bottom casing and a face casing connected to each other, and further comprises gas valves and a gas pipe that are communicated with each other, wherein the gas stove further comprises glands, the glands are annular, outer edges of the glands are pressed onto the face casing, inner edges of the glands extend to inner sides of the mounting through holes, and portions of the glands that are located on the inner sides of the mounting through holes are fixedly connected to the gas valves. The present invention has the advantage that positions of the knobs and the mounting through holes are relatively fixed, such that the knobs can be kept coaxial with the mounting through holes.

### CROSS-REFERENCE TO RELATED APPLICATIONS

This is a U.S. patent application which claims the priority and benefit of Chinese Patent Application Number 202510242584.1, filed on Mar. 3, 2025, the disclosure of which is incorporated herein by reference in its entirety.

### TECHNICAL FIELD

The present invention relates to the field of gas stoves, in particular to a gas stove and a method for mounting the same.

### BACKGROUND ART

An existing gas stove comprises a face casing provided with mounting holes, and further comprises gas valves and knobs mounted on the gas valves. The gas valves are located below the mounting holes, and the knobs are located above the mounting holes.

The bottom of the face casing is connected to a bottom casing. The gas valves are connected to a gas pipe. The gas valves and the gas pipe are fixedly connected to the bottom casing. There is no direct connection relationship between a combination of the gas valves and the knobs and the face casing. After the gas stove has undergone long-distance transportation or other conditions, the knobs and the mounting holes on the face casing are prone to axial misalignment, resulting in uneven gaps around the knobs and affecting the appearance of the gas stove.

### SUMMARY OF THE INVENTION

In order to solve the above technical problems, the purpose of the present invention is to provide a gas stove and a method for mounting the same, which have the advantage that positions of knobs and mounting holes on a face casing are relatively fixed.

The technical solution adopted by the present invention to solve the problem is: a gas stove and a method for mounting the same, comprising
a gas stove, comprising a bottom casing and a face casing that are connected to each other, and further comprising gas valves and a gas pipe that are communicated with each other, the face casing being provided with mounting through holes, wherein the gas stove further comprises glands, the glands are annular, outer edges of the glands are pressed onto the face casing, inner edges of the glands extend to inner sides of the mounting through holes, and portions of the glands that are located on the inner sides of the mounting through holes are fixedly connected to the gas valves; and the gas valves comprise valve stems, the valve stems pass through the glands, upper ends of the valve stems are connected to knobs, the knobs are in a shape of a column with an open bottom, and gaps are provided between side walls of the knobs and the glands.

As a further improvement of the above technical solution, the glands are provided with first connection holes, the gas valves are provided with second connection holes, the first connection holes are connected to the second connection holes by screws, and the first connection holes are concealed below the knobs.

As a further improvement of the above technical solution, the tops of the glands are provided with annular protrusions, the annular protrusions are arranged on outer sides of the first connection holes, and the annular protrusions extend into the knobs.

As a further improvement of the above technical solution, the gland comprises an annular upper cover body and an annular lower cover body, the lower cover body is made of metal, the lower cover body is provided with limiting holes, the upper cover body is provided with clamping jaws, the clamping jaws protrude outwards and are in clamped connection to the face casing, and the clamping jaws pass through the limiting holes.

As a further improvement of the above technical solution, the gas stove further comprises annular baffles, the gas valves are provided with circuit boards, the circuit boards are provided with lamp beads, the circuit boards are provided with third through holes, the third through holes are arranged between the first through holes and the second through holes, the baffles are arranged between the circuit boards and the glands, outer edges of the baffles extend to outer sides of the gas valves, and the upper cover bodies and the baffles are made of transparent plastic.

As a further improvement of the above technical solution, the gas stove further comprises a bracket, the bracket is provided with first mounting holes and second mounting holes, the gas valves are provided with third mounting holes, and the bottom casing is provided with fourth mounting holes and avoiding holes; the avoiding holes are arranged on outer sides of the first mounting holes, the first mounting holes are connected to the third mounting holes by screws, and the second mounting holes are connected to the fourth mounting holes by screws; and the gas pipe is arranged between the bracket and the gas valves.

As a further improvement of the above technical solution, the gas stove further comprises L-shaped supporting angle brackets, the L-shaped supporting angle brackets are fixedly connected to an inner wall of the bottom casing, and the gas pipe is lapped on the L-shaped supporting angle brackets.

As a further improvement of the above technical solution, the gas pipe comprises a first round pipe section, a corrugated pipe section, and a second round pipe section which are communicated in sequence, the gas valves are communicated with the first round pipe section, and the second round pipe section is fixedly connected to the bottom casing. A method for mounting a gas stove, used for mounting the gas stove, the gas pipe comprising the first round pipe section, the corrugated pipe section and the second round pipe section which are communicated in sequence, and further comprising the L-shaped supporting angle brackets, and the L-shaped supporting angle brackets being fixedly connected to the inner wall of the bottom casing, wherein the method comprises the following steps:

S1,
mounting the face casing: mounting the glands on the mounting through holes, and fixedly connecting the glands to the gas valves;
mounting the bottom casing: mounting the L-shaped supporting angle brackets on the bottom casing, and mounting the second round pipe section on the bottom casing;

S2, placing the bracket on the L-shaped supporting angle brackets, and lapping the first round pipe section on the L-shaped supporting angle brackets; connecting the face casing and the bottom casing to each other, and at the same time, communicating the gas valves with the first round pipe section; and

S3, fixedly connecting the bottom casing to the bracket by screws, and fixedly connecting the bracket to the gas valves by screws.

The present invention has the beneficial effects that positions of the glands and the mounting through holes are relatively fixed, the glands are fixed to the gas valves, and the knobs are mounted on upper ends of the valve stems; and therefore, after the knobs and the mounting through holes are mounted, no relative translation occurs, thereby ensuring that the mounting through holes are kept coaxial at all times.

### BRIEF DESCRIPTION OF THE DRAWINGS

The present invention will be further explained with reference to the accompanying drawings and specific implementations.

FIG. 1 is a top view of a preferred implementation of the present invention;

FIG. 2 is a perspective view of a preferred implementation of the present invention;

FIG. 3 is an A-A sectional view of FIG. 1;

FIG. 4 is an enlarged view of part B in FIG. 3;

FIG. 5 is an exploded view of some parts;

FIG. 6 is an assembling schematic view of a bottom casing and some parts; and

FIG. 7 is an exploded view of some parts.

In the drawings: 1—bottom casing, 11—fourth mounting hole, 12—avoiding hole, 2—face casing, 21—mounting hole, 3—gas valve, 31—valve stem, 32—second connection hole, 33—third mounting hole, 4—knob, 5—gas pipe, 51—first round pipe section, 52—corrugated pipe section, 53—second round pipe section, 6—gland, 61—upper cover body, 611—clamping jaw, 62—lower cover body, 621—limiting hole, 63—first connection hole, 64—annular protrusion, 7—baffle, 8—circuit board, 81—third through hole, 9—bracket, 91—first mounting hole, 92—second mounting hole, 10—L-shaped supporting angle bracket.

### DETAILED DESCRIPTION OF EMBODIMENTS

This section will describe the specific embodiments of the present invention in detail. The preferred embodiments of the present invention are shown in the accompanying drawings. The accompanying drawings function as supplementing the description in the text portion of the specification with figures, so that one can intuitively and vividly understand each technical feature and the overall technical solution of the present invention, but it cannot be understood as limiting the protection scope of the present invention.

In the description of the present invention, it should be understood that in terms of orientation description, orientation or position relationships indicated by terms such as “up”, “down”, “front”, “rear”, “left” and “right” are orientation or position relationships shown based on the accompanying drawings, and are only for facilitating the description of the present invention and simplifying the description, but not for indicating or implying that apparatuses or elements referred to must have specific orientations or be constructed and operated in specific orientations, and thus cannot be understood as limiting the present invention.

In the description of the present invention, “several” means one or more, “a plurality of” means two or more, “greater than”, “less than”, “more than”, etc. are understood as excluding the number itself, and “above”, “below”, “within”, etc. are understood as including the number itself. “First”, “second”, etc., if described, are for the purpose of distinguishing technical features only, but cannot be understood as indicating or implying a relative importance or implicitly indicating the number of technical features indicated or implicitly indicating the precedence of technical features indicated.

In the description of the present invention, unless otherwise clearly defined, terms such as “arrange”, “mount” and “connect” should be understood in a broad sense, and those skilled in the art can reasonably determine the specific meanings of the above terms in the present invention with reference to the specific content of the technical solution.

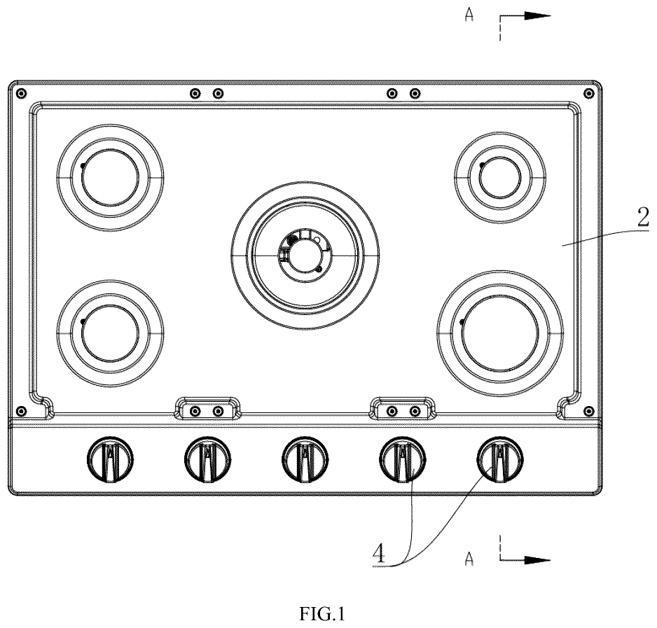

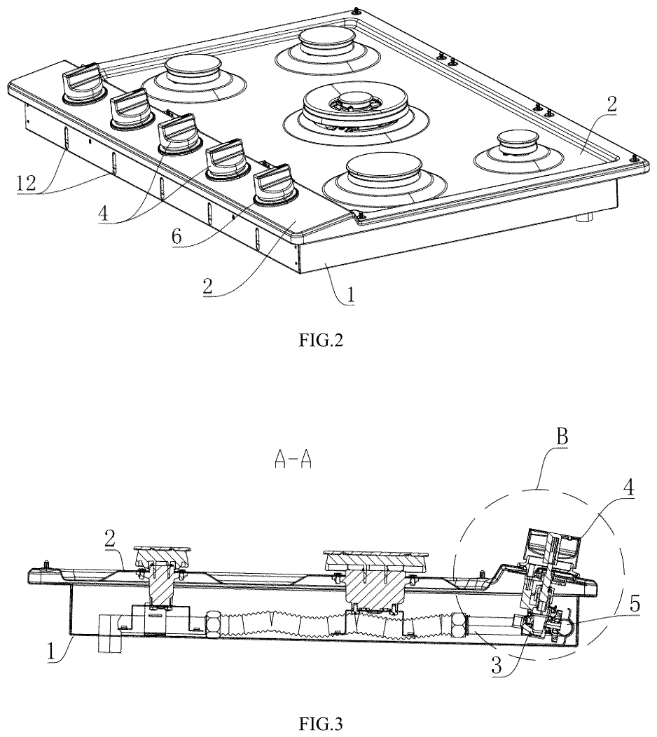

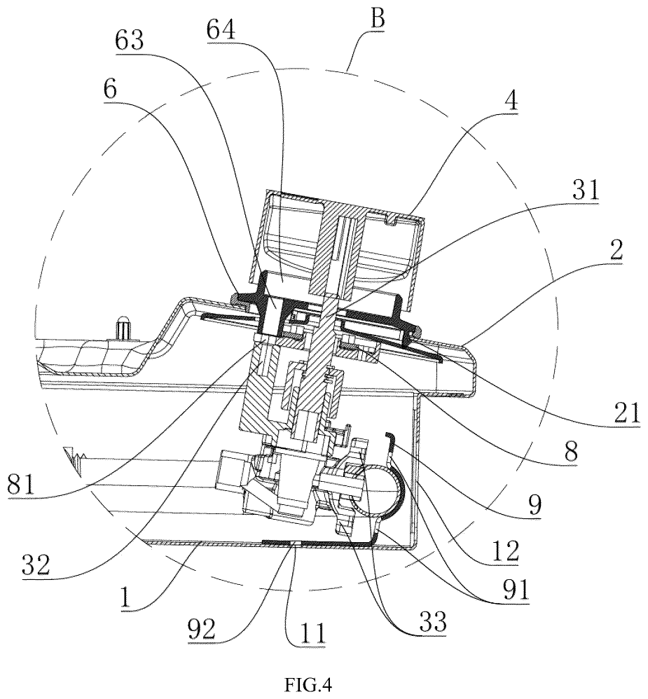

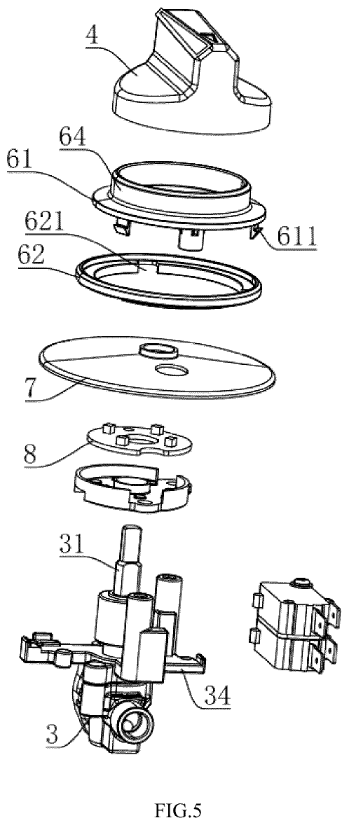

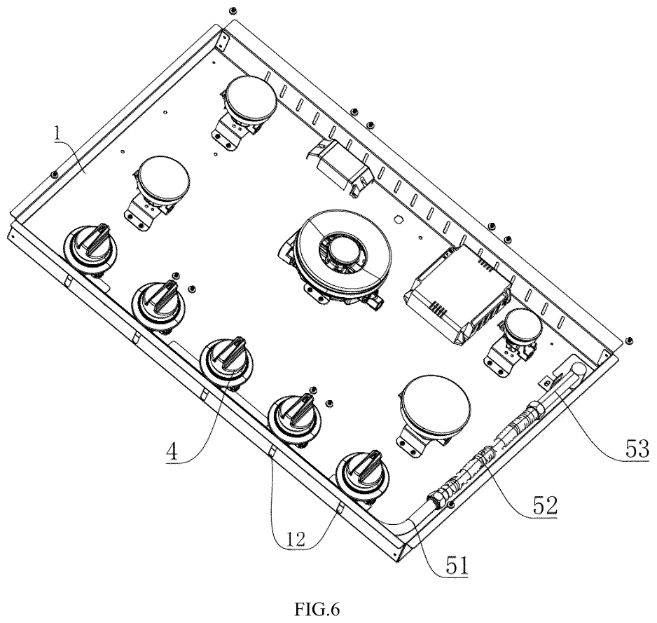

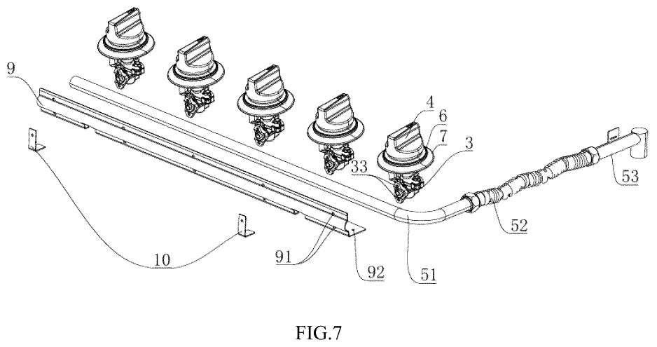

Referring to FIG. 1 to FIG. 7, a gas stove comprises:
a bottom casing 1 and a face casing 2 that are connected to each other, and further comprises gas valves 3 and a gas pipe 5 that are communicated with each other, the face casing 2 being provided with mounting through holes 21, wherein the gas stove further comprises glands 6, the glands 6 are annular, outer edges of the glands 6 are pressed onto the face casing 2, inner edges of the glands 6 extend to inner sides of the mounting through holes 21, and portions of the glands 6 that are located on the inner sides of the mounting through holes 21 are fixedly connected to the gas valves 3; and the gas valves 3 comprise valve stems 31, the valve stems 31 pass through the glands 6, upper ends of the valve stems 31 are connected to knobs 4, the knobs 4 are in a shape of a column with an open bottom, and gaps are provided between side walls of the knobs 4 and the glands 6.

The principle by which the present invention achieves the effect thereof is that the annular glands 6 are provided, the outer edges of the glands 6 are pressed onto the face casing 2 and play a decorative role, the positions of the glands 6 and the mounting through holes 21 are relatively fixed, the glands 6 are fixed to the gas valves 3, and the knobs 4 are mounted on upper ends of the valve stems 31; and therefore, after the knobs 4 and the mounting through holes 21 have been mounted, no relative translation occurs, thereby ensuring that the mounting through holes 21 are kept coaxial at all times.

In a preferred embodiment, the glands 6 are provided with first connection holes 63, the gas valves 3 are provided with second connection holes 32, the first connection holes 63 are connected to the second connection holes 32 by screws, and the first connection holes 63 are concealed below the knobs 4. During mounting, the first connection holes 63 are firstly connected to the second connection holes 32 by the screws, and the knobs 4 are then mounted on the valve stems 31.

In a preferred embodiment, the tops of the glands 6 are provided with annular protrusions 64, the annular protrusions 64 are arranged on outer sides of the first connection holes 63, and the annular protrusions 64 extend into the knobs 4. The knobs 4 and the annular protrusions 64 together play a role in preventing dirt from entering the gas stove via the mounting through holes 21.

In a preferred embodiment, the gland 6 comprises an annular upper cover body 61 and an annular lower cover body 62, the lower cover body 62 is made of metal, the lower cover body 62 is provided with limiting holes 621, the upper cover body 61 is provided with clamping jaws 611, the clamping jaws 611 protrude outwards and are in clamped connection to the face casing 2, and the clamping jaws 611 pass through the limiting holes 621. The lower cover bodies 62 can play a certain sealing role to avoid gaps between the outer edges of the glands 6 and the face casing 2. In addition, the lower cover bodies 62 made of metal match the transparent upper cover bodies 61, having an advantage of aesthetics.

In a preferred embodiment, the gas stove further comprises annular baffles 7, the gas valves 3 are provided with circuit boards 8, the circuit boards 8 are provided with lamp beads, the circuit boards 8 are provided with third through holes 81, the third through holes 81 are arranged between the first through holes and the second through holes, the baffles 7 are arranged between the circuit boards 8 and the glands 6, outer edges of the baffles 7 extend to outer sides of the gas valves 3, and the upper cover bodies 61 and the baffles 7 are made of transparent plastic. The baffles 7 and the glands 6 are light-transmissive, such that light generated by the lamp beads on the circuit boards 8 is transmitted through edges of the knobs 4.

In a preferred implementation, the gas stove further comprises a bracket 9, the bracket 9 is provided with first mounting holes 91 and second mounting holes 92, the gas valves 3 are provided with third mounting holes 33, and the bottom casing 1 is provided with fourth mounting holes 11 and avoiding holes 12; the avoiding holes 12 are arranged on outer sides of the first mounting holes 91, the first mounting holes 91 are connected to the third mounting holes 33 by screws, and the second mounting holes 92 are connected to the fourth mounting holes 11 by screws; and the gas pipe 5 is arranged between the bracket 9 and the gas valves 3. Such arrangement has the advantage that the gas valves 3 and the bottom casing 1 can be fixed after the bottom casing 1 is snap-fitted to the face casing 2. Specifically, the screws are driven from the bottom of the bottom casing 1 to connect the second mounting holes 92 and the fourth mounting holes 11, thereby fixedly connecting the bottom casing 1 to the bracket 9; and the screws are driven to pass through the avoiding holes 12 to connect the first mounting holes 91 to the third mounting holes 33, thereby fixedly connecting the bracket 9 to the gas valves 3, and relatively fixing the gas pipe 5 to the gas valves 3 at the same time. This differs from conventional gas stove production processes, in which the step of snap-fitting the bottom casing to the face casing is performed after the step of fixing the gas valves 3 to the bottom casing 1.

In a preferred implementation, the gas stove further comprises L-shaped supporting angle brackets 10, the L-shaped supporting angle brackets 10 are fixedly connected to an inner wall of the bottom casing 1, and the gas pipe 5 is lapped on the L-shaped supporting angle brackets 10. Before the bottom casing 1 is snap-fitted to the face casing 2, the gas pipe 5 is positioned by being lapped on the L-shaped supporting angle brackets 10, thereby ensuring correct relative positions between the gas pipe 5 and the gas valves 3 during the subsequent snap-fitting between the bottom casing 1 and the face casing 2.

In a preferred implementation, the gas pipe 5 comprises a first round pipe section 51, a corrugated pipe section 52, and a second round pipe section 53 which are communicated in sequence, the gas valves 3 are communicated with the first round pipe section 51, and the second round pipe section 53 is fixedly connected to the bottom casing 1. During mounting, the second round pipe section 53 is fixedly connected to the bottom casing 1, and the gas valves 3 are then communicated with the first round pipe section 51 when the bottom casing 1 is snap-fitted to the face casing 2.

The present invention further provides a method for mounting a gas stove, used for mounting the gas stove, the gas pipe 5 comprising the first round pipe section 51, the corrugated pipe section 52 and the second round pipe section 53 which are communicated in sequence, and further comprising the L-shaped supporting angle brackets 10, the L-shaped supporting angle brackets 10 being fixedly connected to the inner wall of the bottom casing 1, wherein the method comprises the following steps:

S1,
mounting the face casing 2: mounting the glands 6 on the mounting through holes 21, and fixedly connecting the glands 6 to the gas valves 3;
mounting the bottom casing 1: mounting the L-shaped supporting angle brackets 10 on the bottom casing 1, and mounting the second round pipe section 53 on the bottom casing 1;

S2, placing the bracket 9 on the L-shaped supporting angle brackets 10, and lapping the first round pipe section 51 on the L-shaped supporting angle brackets 10; connecting the face casing 2 and the bottom casing 1 to each other, and at the same time, communicating the gas valves 3 with the first round pipe section 51; and

S3, fixedly connecting the bottom casing 1 to the bracket 9 by screws, and fixedly connecting the bracket 9 to the gas valves 3 by screws. When the bracket 9 is fixedly connected to the gas valves 3, since the first round pipe section 51 is clamped between the bracket 9 and the gas valves 3, the first round pipe section 51 can also be fixedly connected to the gas valves 3.

The above are only preferred embodiments of the present invention, and are not intended to limit the patentable scope of the present invention. All equivalent structural transformations made by using the content of the specification and accompanying drawings of the present invention under the inventive concept of the present invention, or directly/indirectly applied to other related technical fields are included in the patent protection scope of the present invention.

What is claimed is:

1. A gas stove, comprising a bottom casing (1) and a face casing (2) that are connected to each other, and further comprising gas valves (3) and a gas pipe (5) that are communicated with each other, the face casing (2) being provided with mounting through holes (21), wherein
the gas stove further comprises glands (6), the glands (6) are annular, outer edges of the glands (6) are pressed onto the face casing (2), inner edges of the glands (6) extend to inner sides of the mounting through holes (21), and portions of the glands (6) that are located on the inner sides of the mounting through holes (21) are fixedly connected to the gas valves (3); and
the gas valves (3) comprise valve stems (31), the valve stems (31) pass through the glands (6), upper ends of the valve stems (31) are connected to knobs (4), the knobs (4) are in a shape of a column with an open bottom, and gaps are provided between side walls of the knobs (4) and the glands (6).

2. The gas stove according to claim 1, wherein
the glands (6) are provided with first connection holes (63), the gas valves (3) are provided with second connection holes (32), the first connection holes (63) are connected to the second connection holes (32) by screws, and the first connection holes (63) are concealed below the knobs (4).

3. The gas stove according to claim 1, wherein
the tops of the glands (6) are provided with annular protrusions (64), the annular protrusions (64) are arranged on outer sides of the first connection holes (63), and the annular protrusions (64) extend into the knobs (4).

4. The gas stove according to claim 1, wherein
the gland (6) comprises an annular upper cover body (61) and an annular lower cover body (62), the lower cover body (62) is made of metal, the lower cover body (62) is provided with limiting holes (621), the upper cover body (61) is provided with clamping jaws (611), the clamping jaws (611) protrude outwards and are in clamped connection to the face casing (2), and the clamping jaws (611) pass through the limiting holes (621).

5. The gas stove according to claim 1, wherein
the gas stove further comprises annular baffles (7), the gas valves (3) are provided with circuit boards (8), the circuit boards (8) are provided with lamp beads, the circuit boards (8) are provided with third through holes (81), the third through holes (81) are arranged between the first through holes and the second through holes, the baffles (7) are arranged between the circuit boards (8) and the glands (6), outer edges of the baffles (7) extend to outer sides of the gas valves (3), and the upper cover bodies (61) and the baffles (7) are made of transparent plastic.

6. The gas stove according to claim 1, wherein
the gas stove further comprises a bracket (9), the bracket (9) is provided with first mounting holes (91) and second mounting holes (92), the gas valves (3) are provided with third mounting holes (33), and the bottom casing (1) is provided with fourth mounting holes (11) and avoiding holes (12);
the avoiding holes (12) are arranged on outer sides of the first mounting holes (91), the first mounting holes (91) are connected to the third mounting holes (33) by screws, and the second mounting holes (92) are connected to the fourth mounting holes (11) by screws; and
the gas pipe (5) is arranged between the bracket (9) and the gas valves (3).

7. The gas stove according to claim 1, wherein
the gas stove further comprises L-shaped supporting angle brackets (10), the L-shaped supporting angle brackets (10) are fixedly connected to an inner wall of the bottom casing (1), and the gas pipe (5) is lapped on the L-shaped supporting angle brackets (10).

8. The gas stove according to claim 7, wherein
the gas pipe (5) comprises a first round pipe section (51), a corrugated pipe section (52), and a second round pipe section (53) which are communicated in sequence, the gas valves (3) are communicated with the first round pipe section (51), and the second round pipe section (53) is fixedly connected to the bottom casing (1).

9. A method for mounting a gas stove, used for mounting the gas stove according to claim 1, the gas pipe (5) comprising the first round pipe section (51), the corrugated pipe section (52) and the second round pipe section (53) which are communicated in sequence, and further comprising the L-shaped supporting angle brackets (10), and the L-shaped supporting angle brackets (10) being fixedly connected to the inner wall of the bottom casing (1), wherein the method comprises the following steps:
S1,
mounting the face casing (2): mounting the glands (6) on the mounting through holes (21), and fixedly connecting the glands (6) to the gas valves (3);
mounting the bottom casing (1): mounting the L-shaped supporting angle brackets (10) on the bottom casing (1), and mounting the second round pipe section (53) on the bottom casing (1);
S2, placing the bracket (9) on the L-shaped supporting angle brackets (10), and lapping the first round pipe section (51) on the L-shaped supporting angle brackets (10); connecting the face casing (2) and the bottom casing (1) to each other, and at the same time, communicating the gas valves (3) with the first round pipe section (51); and
S3, fixedly connecting the bottom casing (1) to the bracket (9) by screws, and fixedly connecting the bracket (9) to the gas valves (3) by screws.
